(19) United States
(12) Patent Application Publication
(10) Pub. No.: US 2025/0278256 A1
(43) Pub. Date: Sep. 4, 2025

(54) EFFICIENT COMPILATION METHOD FOR MULTI-CORE QUANTUM COMPUTERS

(71) Applicant: IonQ Quantum Canada, Inc., Toronto (CA)

(72) Inventors: Edwin THAM, Toronto (CA); llia KHAIT, Toronto (CA); Aharon BRODUTCH, Toronto (CA)

(21) Appl. No.: 18/806,462

(22) Filed: Aug. 15, 2024

Related U.S. Application Data
(63) Continuation of application No. PCT/IB2023/051562, filed on Feb. 21, 2023.
Application No. PCT/IB2023/051562 is a continuation-in-part of application No. 63/312,423, filed on Feb. 22, 2022.

(51) Int. Cl. G06F 8/41

(52) U.S. Cl. CPC G06F 8/41

(57) ABSTRACT

A method is provided for mapping a quantum program code to a multi-core quantum computing system. The method includes partitioning code into code segments; identifying, from the code segments, a first group (Gc) comprising at least parts of possible contiguous sequences of the code segments; identifying a second group (Gnc) comprising at least part of possible non-overlapping combinations of Gc members; converting each Gc member to a corresponding graph group (Ggc); mapping logical qubits contained in each Gc member to different physical cores; generating a respective group of solver results (Gsc); determining an amount of inter-operations (Asc) related to the contiguous code part corresponding to a respective Gsc; determining a group of inter-operation amounts (Gamnt) based on the Asc; and determining an optimal compiled code structure having a smallest amount of Gamnt members.

### CROSS REFERENCE TO RELATED APPLICATIONS

This application is a continuation of International Application No. PCT/IB2023/051562, filed Feb. 21, 2023, which claims priority to U.S. Patent Provisional Application No. 63/312,423, filed Feb. 22, 2022, the entire contents of each of which are hereby incorporated in their entirety.

### TECHNICAL FIELD

The present invention relates generally to quantum computers programming, and more particularly to methods and systems that provide optimized techniques of mapping quantum program code to multi-core quantum computing systems.

### BACKGROUND

Modular Quantum Computing architectures consisting of multiple quantum cores have been proposed in the academic and patent literature as a method for scaling quantum computers, see, for example, U.S. Pat. No. 9,858,531B. In such architectures, each core contains a limited number of qubits. Qubits on different cores can interact via various solutions of inter-core communication, for example, by using entanglement generated with an optical interconnect, see for example David Awschalom et al. PRX Quantum 2, 017002. Another solution may be shuttling qubits between cores, see for example Kielpinski, D., Monroe, C. & Wineland, D. Nature 417, 709-711 (2002). Inter-core communication can be used to move information around in one of two ways: (a) interoperations: where two qubits on different cores interact indirectly e.g., by using remote gates, (b) information exchange operations where the information encoded in a qubit is moved to another qubit on a different core e.g. using teleportation.

Quantum compilers are used to take quantum code and modify it in order to improve execution on some target architecture. In many cases compilers include subroutines for optimal mapping of logical qubits to physical qubits. In general, the output of a compiler is a modified code which can be used as the input for another pass of the same or a different compiler. Once all compiler passes are completed, the resulting code is run on the quantum computer. Different compilers for multi-core architectures have been designed to improve performance by either minimizing the number of inter-operations or minimizing the number of information exchange operations. Missing in the art is a compilation method that would optimize performance while accounting for both of the above means.

### SUMMARY

In accordance with an embodiment of the present invention, a processor-implemented method is disclosed for compiling quantum program code, hereinafter denoted as “code”, so as to improve its execution performance over a multi-core quantum computing system, hereinafter denoted as “system”. In a typical embodiment, the cores are linked by entanglement-based one-time-use links whose generation time duration varies randomly. The code comprises core local instructions and instructions that involve multiple cores thus needing those entanglement-based inter core links. The disclosed method comprises the following compilation steps:

Step (a) comprises partitioning the code to two or more successive segments based on some predetermined rules. A partitioning example may be uniform partitioning, in terms of inter- qubit logical operations, to two or more segments. In some embodiments, the segmentation is determined based on identifying code characteristics differences between adjacent segments.

Step (b) comprises identifying a group, denoted as “Gc”, that includes at least part of all possible contiguous sequences of one or more code segments. In some embodiments, a criterion of not including all the contiguous sequences may be ensuring a minimum length difference therebetween, in terms of inter-qubit logical operations. A segment that includes the entire code is typically included in Gc.

Step (c) that follows comprises identifying a group, denoted as “Gnc”, that includes at least part of all possible non-overlapping combinations of Gc members. If Gc magnitude is high, the number of resulted Gnc members may entail too complex computation in the following steps. Therefore, in some embodiments, only a part thereof is considered; an example criterion may be some minimum length difference between the chosen combinations.

Step (d), also directly based on step (b), comprises converting each Gc member to a corresponding graph, thus creating a respective graph group, denoted as “Ggc”. The conversion is performed by associating each logical qubit contained in the contiguous code part constituting the converted Gc member with a different vertex in the graph, and then associate each inter-qubit operation in the converted Gc member with a different edge between the pair of vertices corresponding to that operation.

Next, in step (e), a graph-solver program, denoted as “solver”, is provided. Such a program, may be achieved over the Internet, possibly under an open-source license. The purpose of employing the solver is to map the logical qubits contained in each Gc member to the different physical cores. The solver does it by processing the graph corresponding to each Gc member as follows: partitioning the graph vertices into exclusive groups representing the system cores such that the groups number and magnitudes are constrained by the number of the system cores and number of physical qubits within each core respectively, while attempting to minimize the total amount of the resulting inter-group edges, which corresponds to the amount of operations between different cores, denoted as “inter-operations”.

Step (f) coming next comprises the actual application of the solver to all the Ggc graphs, thus creating a respective group of solver results, denoted “Gsc”, wherein each Gsc member now corresponds to a respective Gc member and to its corresponding contiguous code part now already containing physical qubits. The solver application to any Gsc member graph also provides the amount, denoted as “Asc”, of inter-operations now related to the contiguous program part corresponding to that Gsc member.

Step (g) that follows comprises calculating a group of inter-operation amounts, denoted as “Gamnt”, one-to-one corresponding to Gnc and calculated as follows:
I. For the Gnc member that is the entire code segment, determining its corresponding Gamnt member as the Asc associated with the Gsc member, denoted as Cse, corresponding to the entire code segment.
II. For any Gnc member that is not the entire code segment, calculating its associated Gamnt member by summing the Asc amounts associated with all the Gsc members corresponding to that any Gnc member, and for all the code parts outside those all Gsc members, if there are such code parts, also including in the calculated Gamnt the amount of all the Cse inter-operations belonging to said outside code parts.
III. For any Gnc member that is not the entire code segment, also including in the Gamnt member calculated in II above penalties that are possibly associated with code transitions between adjacent Gsc members, and/or therebetween and Cse code parts outside thereof, wherein the penalty associated with each such transition is calculated as the amount of inter-operations needed to transfer qubits between cores due to this each such transitions. In some embodiments, these operations comprise in typical embodiments qubit teleportation.

Step (h) comprises determining the optimal compiled code structure, in the sense of having minimum amount of inter-operations, i.e., having minimum Gamnt member, as follows:
I. Selecting the Gnc member for which the minimum Gamnt member is achieved in step (g) above.
II. Expressing the code in physical qubit terms according to the Gsc members corresponding to the selected Gnc member and the Cse code parts outside thereof, and
III. Adding to the code inter-operations for transferring qubits between cores, if needed, based on step (g) III above.

In some embodiments, the calculation of the Asc amounts take into consideration weighting that is associated with the edges of the solver processed graphs, i.e., with the code logical operations. In those and also in other embodiments, calculating the Gamnt members comprises using weighted sums of the involved inter-operations, including those associated with qubit transfer operations.

In some embodiments an optional step may be applied when the system is structured such that some cores are connected to the other cores through physical connections having substantially higher latency than that of the physical connections interconnecting the other cores. This step comprises remapping logical qubits to physical qubits such that those cores having high latency physical connections would be involved with less inter-operations per core relative to the other cores.

In some embodiments, at least part of the code segments is predetermined based on the following criterion of limited qubit distribution in a segment: the ratio between the number of different qubits in the segment to the total number of inter-qubit operations therein is not greater than a predetermined maximum threshold. In one of those embodiments, the system is computationally scaled down for at least part of the Gc members not meeting the above-mentioned criterion, by calculating for such Gc members the above-mentioned ratio, and computationally scaling down the system for that at least part of the Gc members by the calculated ratio, provided that this calculated ratio is not lower than a predetermined minimum threshold higher than the above maximum threshold.

Embodiments of the present invention also include various processing arrangements for carrying out the above method steps. Such processing arrangements may be, but is not limited to, a conventional computer or server, either desktop or mobile, a distributed computerized system, a quantum computer and any suitable combination thereof.

### BRIEF DESCRIPTION OF THE DRAWINGS

The present invention will be more fully understood from the following detailed description of the embodiments thereof, taken together with the drawings in which:

FIG. 1 depicts a flowchart that schematically illustrates a method of compiling a quantum program code to a multi-core quantum computing system, in accordance with an embodiment of the present invention.

FIGS. 2a to 2j depicts compilation of an example quantum program code for a physical multicore quantum computing system, in accordance with an embodiment of the present invention.

### DETAILED DESCRIPTION OF EMBODIMENTS

Embodiments of the present invention provide processor-implemented methods of optimizing a quantum program code, comprising logical qubits. In these embodiments, the code shall be executed on a multi-core quantum computing system, having a known number of cores and known number of physical qubits in each core. The optimization is achieved by mapping logical code qubits to physical qubits in the system cores, while attempting to minimize the total inter-core operations, denoted as “inter-operations”. The rationale of this optimization strategy is that such inter-operations are typically performed through a high latency interconnect system. Such a system may employ entanglement-based one-time-use Einstein-Podolsky-Rosen (EPR) links, whose generation time duration varies randomly and typically takes much longer time than inter-qubit operation time inside the individual cores. Minimizing the amount of such links also helps to increase the code execution reliability. An additional advantage provided by the disclosed techniques is achieving the above optimization with reasonable computational burden.

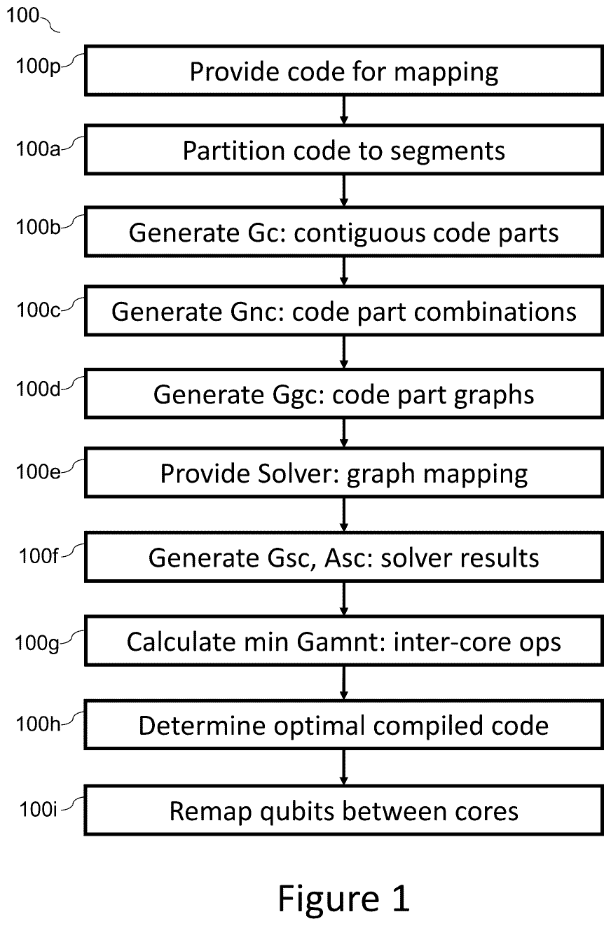

Referring now to FIG. 1, there is shown a flowchart 100, which schematically illustrates a method of mapping a quantum program code to a multi-core quantum computing system, in accordance with an embodiment of the present invention. The flowchart begins with method step 100p, where a code is provided for mapping to a given system, as described above. Step 100a comprises partitioning the code to two or more successive segments based on some predetermined rules. A partitioning example may be uniform partitioning, in terms of inter-qubit logical operations, to two or more segments. In some embodiments, the segmentation is determined based on identifying code characteristics differences between adjacent segments.

Step 100b comprises identifying a group, denoted as “Gc”, that includes at least part of all possible contiguous sequences of one or more code segments. In some embodiments, a criterion of not including all the contiguous sequences may be ensuring a minimum length difference therebetween, in terms of inter-qubit logical operations. A segment that includes the entire code is typically included in Gc. In some embodiments, at least part of the code segments is predetermined based on the following criterion of limited qubit distribution in a segment: the ratio between the number of different qubits in the segment to the total number of inter-qubit operations therein is not greater than a predetermined maximum threshold. In one of those embodiments, the system is computationally scaled down for at least part of the Gc members not meeting the above-mentioned criterion, by calculating for such Gc members the above-mentioned ratio, and computationally scaling down the system for that at least part of the Gc members by the calculated ratio, provided that this calculated ratio is not lower than a predetermined minimum threshold higher than the above maximum threshold.

Step 100c that follows comprises identifying a group, denoted as “Gnc”, that includes at least part of all possible non-overlapping combinations of Gc members. If Gc magnitude is high, the number of resulted Gnc members may entail too complex computation in the following steps. Therefore, in some embodiments, only a part thereof is considered; an example criterion may be some minimum length difference between the chosen combinations.

Step 100d, also directly based on step 100b, comprises converting each Gc member to a corresponding graph, thus creating a respective graph group, denoted as “Ggc”. The conversion is performed by associating each logical qubit contained in the contiguous code part constituting the converted Gc member with a different vertex in the graph, and then associate each inter-qubit operation in the converted Gc member with a different edge between the pair of vertices corresponding to that operation.

Next, in step 100e, a graph-solver program, denoted as “solver”, is provided. Such a program, may be achieved over the Internet, possibly under an open-source license. The purpose of employing the solver is to map the logical qubits contained in each Gc member to the different physical cores. The solver does it by processing the graph corresponding to each Gc member as follows: partitioning the graph vertices into exclusive groups representing the system cores such that the groups number and magnitudes are constrained by the number of the system cores and number of physical qubits within each core respectively, while attempting to minimize the total amount of the resulting inter-group edges, which corresponds to the amount of operations between different cores, denoted as “inter-operations”.

Step 100f coming next comprises the actual application of the solver to all the Ggc graphs, thus creating a respective group of solver results, denoted “Gsc”, wherein each Gsc member now corresponds to a respective Gc member and to its corresponding contiguous code part now already containing physical qubits. The solver application to any Gsc member graph also provides the amount, denoted as “Asc”, of inter-operations now related to the contiguous program part corresponding to that Gsc member. In some embodiments, the calculation of the Asc amounts take into consideration weighting that is associated with the edges of the solver processed graphs, i.e., with the code logical operations.

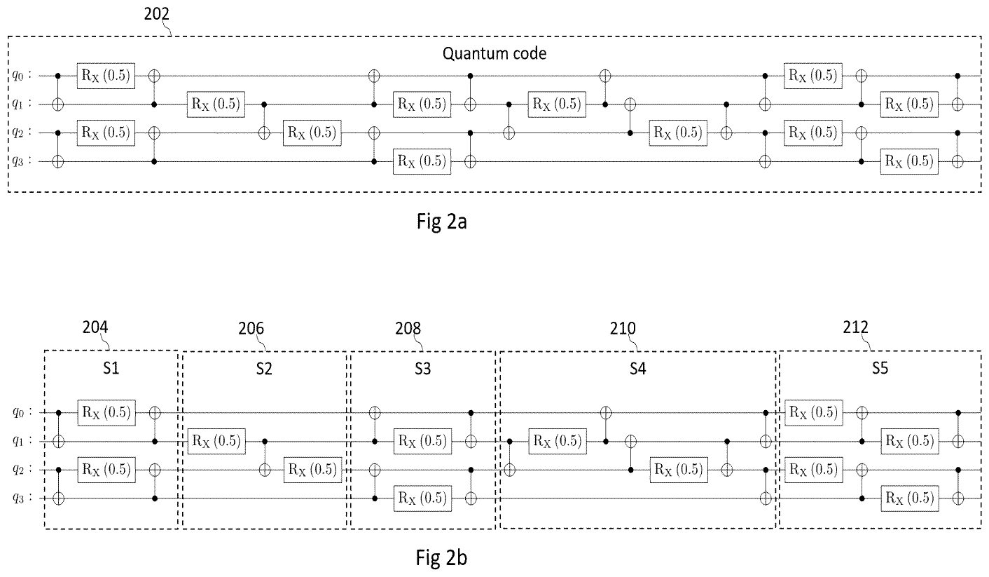

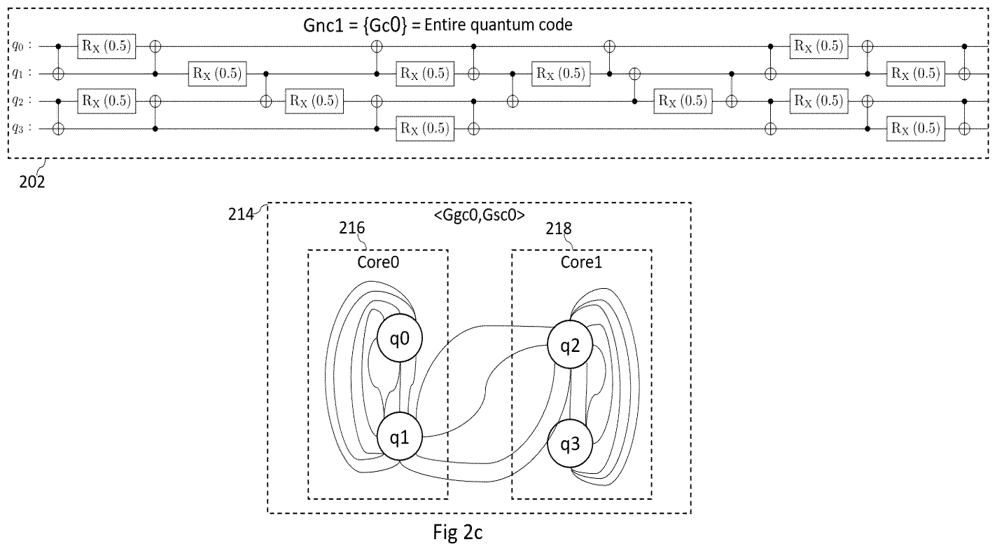

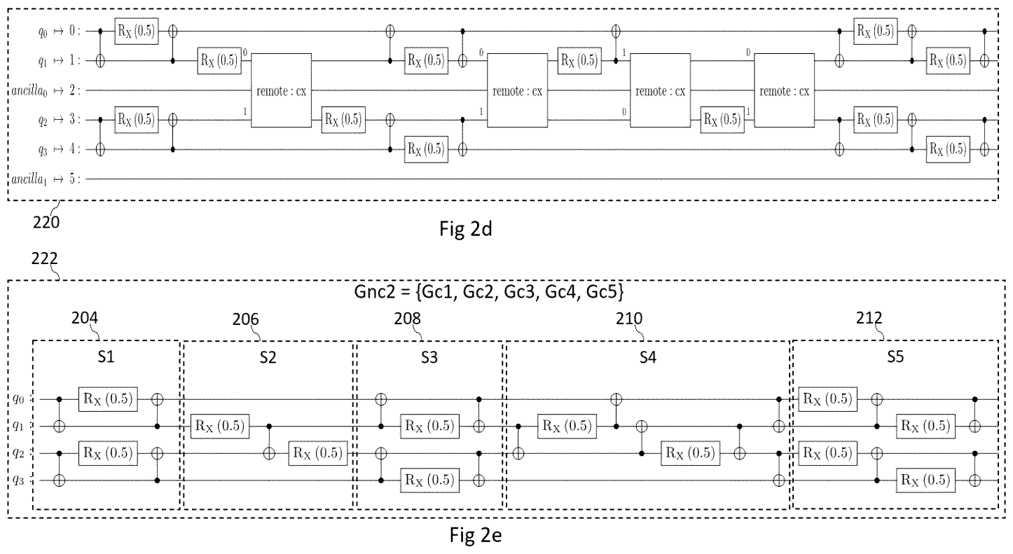

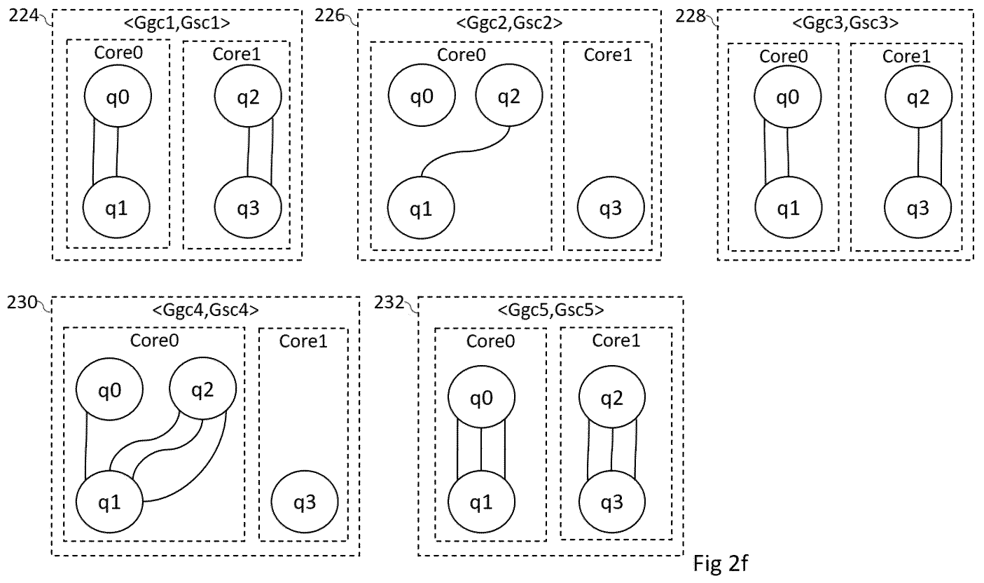

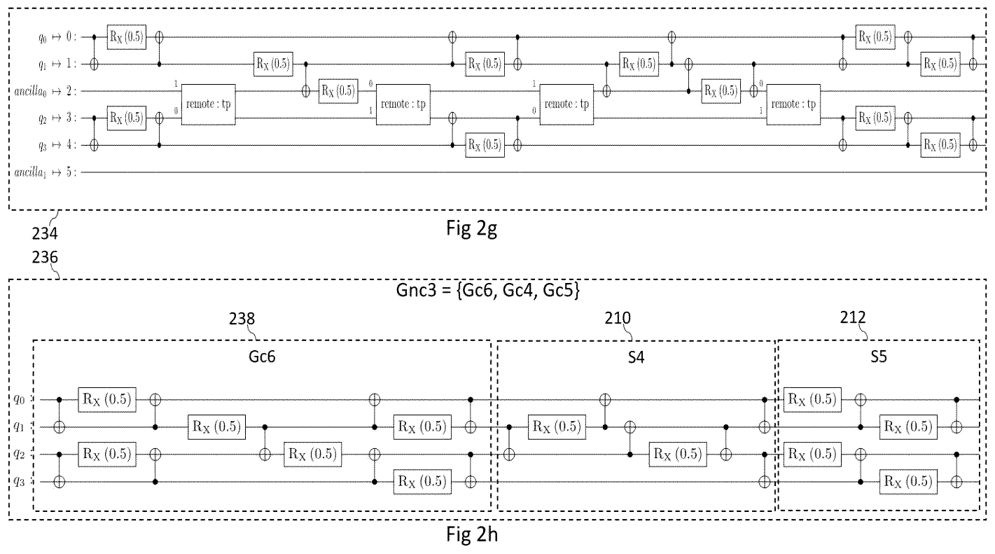

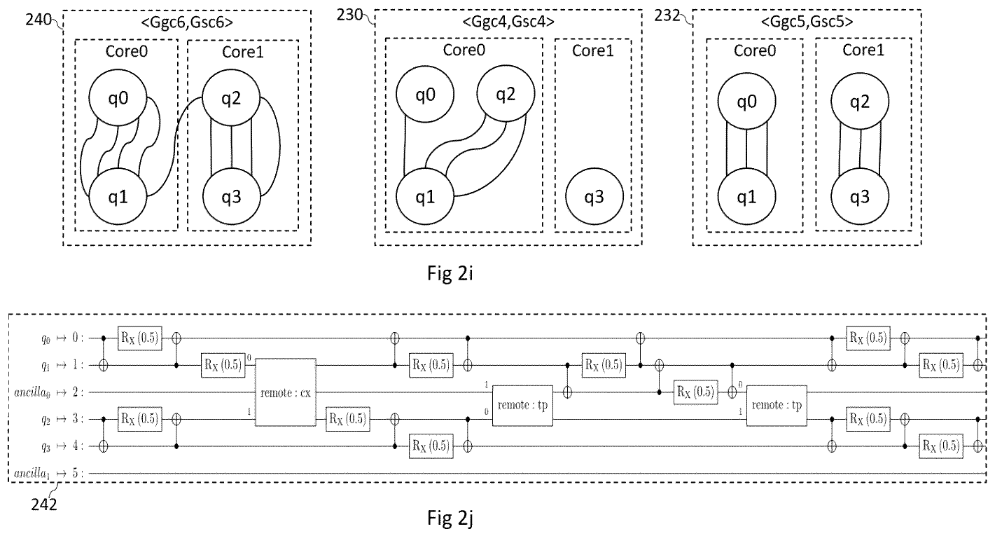

Flowchart 100 proceeds to step 100g that comprises calculating a group of inter-operation amounts, denoted as “Gamnt”, one-to-one corresponding to Gnc and calculated as follows:
I. For the Gnc member that is the entire code segment, determining its corresponding Gamnt member as the Asc associated with the Gsc member, denoted as Cse, corresponding to the entire code segment.
II. For any Gnc member that is not the entire code segment, calculating its associated Gamnt member by summing the Asc amounts associated with all the Gsc members corresponding to that any Gnc member, and for all the code parts outside those all Gsc members, if there are such code parts, also including in the calculated Gamnt the amount of all the Cse inter-operations belonging to said outside code parts.
III. For any Gnc member that is not the entire code segment, also including in the Gamnt member calculated in II above penalties that are possibly associated with code transitions between adjacent Gsc members, and/or therebetween and Cse code parts outside thereof, wherein the penalty associated with each such transition is calculated as the amount of inter-operations needed to transfer qubits between cores due to this each such transitions. In some embodiments, these operations comprise qubit teleportation, denoted as remote: TP in the example depicted in FIG. 2.

In some embodiments, calculating the Gamnt members comprises using weighted sums of the involved inter-operations, including those associated with qubit transfer operations.

Step 100h comprises determining the optimal compiled code structure, in the sense of having minimum amount of inter-operations, i.e., having minimum Gamnt member, as follows:
I. Selecting the Gnc member for which the minimum Gamnt member is achieved in step 100g above.
II. Expressing the code in physical qubit terms according to the Gsc members corresponding to the selected Gnc member and the Cse code parts outside thereof, and
III. Adding to the code inter-operations for transferring qubits between cores, if needed, based on step 100g. III above.

Flowchart 100 terminates with an optional step 100i that may be applied when the system is structured such that some cores are connected to the other cores through physical connections having substantially higher latency than that of the physical connections interconnecting the other cores. This step comprises remapping logical qubits to physical qubits such that those cores having high latency physical connections would be involved with less inter-operations per core relative to the other cores.

Flowchart 100 is an example flowchart, which was chosen purely for the sake of conceptual clarity. In alternative embodiments, any other suitable flowchart can also be used for illustrating the disclosed method. Method steps that are not mandatory for understanding the disclosed techniques were omitted from FIG. 1 for the sake of simplicity.

FIGS. 2a to 2j, which are now described and denoted for brevity “FIG. 2”, illustrate an example of mapping a quantum code 202, depicted in FIG. 2a, to a physical multi-core system, in accordance with an embodiment of the principles of the method steps described above with reference to FIG. 1. Since mapping a real-life practical code would have entailed an enormously complex description, an especially simple code was chosen. Code 202 includes 4 logical qubits q0 to q3 and it has to be compiled for a two-core physical system, each core having 3 physical qubits. For the sake of simplicity, all the logical operations as well as physical inter-operations are assigned an equal weight. For simplicity, also some groups, described with reference to FIG. 1, which have a lot of members are only partially shown.

FIG. 2b, which corresponds to method step 100a, illustrates partitioning of code 202 into 5 segments S1 to S5, indicated by respective reference numerals 204, 206, . . . 212.

Based on step 100b, FIG. 2 show a group Gc of contiguous code parts that can be formed based on the above partitioning: Gc0=[s1|s2|s3|s4|s5]=entire code 202, Gc1=[s1], Gc2=[s2], Gc3=[s3], Gc4=[s4], Gc5=[s5], Gc6=[s1|s2|s3], Gc7=[s1|s2], Gc8=[s3|s4|s5] . . . wherein | indicates segment concatenation so as to form contiguous code.

Based on step 100c, FIG. 2 also show a group Gnc, each of which is a non-overlapping combination of Gc members: Gnc1={Gc0}, Gnc2={Gc1,Gc2,Gc3,Gc4,Gc5}, Gnc3={Gc6, Gc4, Gc5}, Gnc4={Gc7,Gc8}, Gnc5={Gc1, Gc2, Gc8} . . .

Based on steps 100d and 100f, FIG. 2 also respectively show group Ggc and its respective group Gsc. Ggc includes graphs to which their respective Gc members are converted. Gsc includes these Ggc graphs after being mapped, by the solver provided in step 100e, to the aforementioned physical system. The shown graphs are: <Ggc0, Gsc0>, <Ggc1, Gsc1>, <Ggc2,Gsc2>,<Ggc3,Gsc3>, <Ggc4,Gsc4>, <Ggc5,Gsc5>, <Ggc6,Gsc6>.

Based on step 100f, FIG. 2 also show, associated with each Gsc member, a respective Asc member, i.e., AscO to Asc6, indicating the corresponding number of inter-operations between coreO and core1.

Referring now to FIG. 2c, there is shown GcO, which is equal to Gnc1 and to the entire code 202. Also shown their corresponding graph GgcO and its mapped version GscO, which are depicted together as block 214. Block 214 includes cores 216 and 218, which are connected with 4 interoperations. Hence, the amount AscO is equal 4. FIG. 2d depicts a resulting compiled code 220 that is associated with Gnc1, which includes the mapping to cores 216 and 218. The 4 inter-operations of FIG. 2c are indicated as “remote: ex”. As there are no penalties due to code transitions, Gamnt1=AscO=4.

FIG. 2e that follows depicts Gnc2 code structure 222 as specified above. FIG. 2f depicts the Ggc and Gsc members 224, 226 . . . 232 that correspond to Gnc2 code parts. It stems from the Gsc drawings that their respective inter-operations Asc1=Asc2=Asc3=Asc4=Asc5=0. FIG. 2g depicts the compiled code, 234, associated with Gnc2. There are 0 inter-operations (remote: ex) because all the associated Asc members equal 0. However, 4 transitions between mapped code parts result in respective 4 qubit transfers, indicated as “remote: tp”, which results in transfer penalty of 4 teleportations. Summing both the Asc members and the penalty results in Gamnt2=4.

FIG. 2h depicts Gnc3 code structure 236 as specified above. FIG. 2i depicts the Ggc and Gsc members 240, 230 and 232 that correspond to Gnc3 code parts. It stems from the Gsc drawings that their respective inter-operations are Asc6=1 and Asc4=Asc5=0. FIG. 2j depicts the compiled code, 242, associated with Gnc3. There is one inter-operations (remote: ex) contributed by Asc6. However, 2 transitions between mapped code parts result in respective 2 qubit transfers (remote: tp), which results in transfer penalty of 2 teleportations. Summing both the Asc and the penalty components results in Gamnt3=3. This turns to be the optimal compilation, taking into account the above results, as well as results obtained for other Gnc members but not shown in FIG. 2 for the sake of simplicity.

It will thus be appreciated that the embodiments described above are cited by way of example, and that the present invention is not limited to what has been particularly shown and described hereinabove. Rather, the scope of the present invention includes both combinations and sub-combinations of the various features described hereinabove, as well as variations and modifications thereof which would occur to persons skilled in the art upon reading the foregoing description and which are not disclosed in the prior art.

What is claimed:

1. A method for mapping a quantum program code to a multi-core quantum computing system, comprising:
partitioning code into code segments;
identifying, from the code segments, a first group (Gc) comprising at least parts of possible contiguous sequences of the code segments;
identifying a second group (Gnc) comprising at least part of possible non-overlapping combinations of Gc members;
converting each Gc member to a corresponding graph group (Ggc);
mapping logical qubits contained in each Gc member to different physical cores;
generating a respective group of solver results (Gsc), wherein each Gsc corresponds to a respective Gc member and to its corresponding contiguous code part comprising physical qubits;
determining an amount of inter-operations (Asc) related to the contiguous code part corresponding to a respective Gsc;
determining a group of inter-operation amounts (Gamnt) based on the Asc; and
determining an optimal compiled code structure having a smallest amount of Gamnt members.

2. The method of claim 1, further comprising remapping logical qubits to physical qubits such that cores having high latency physical connections are involved with fewer inter-operations per core relative to other cores.

3. The method of claim 1, further comprising segmenting the code to two or more segments based on identifying code characteristics between adjacent segments.

4. The method of claim 1, wherein each identified group has a minimum length difference in regards to inter-qubit logical operations.

5. The method of claim 1, wherein at least part of the code segments are predetermined according to limiting qubit distribution in a segment by a ratio between a number of different qubits in a segment to a total number of inter-qubit operations not being greater than a predetermined threshold.

6. The method of claim 1, further comprising identifying the second group based on a minimum length difference between chosen combinations.

7. The method of claim 1, wherein converting Gc members to a respective graph group comprises:
associating each logical qubit contained in the contiguous code part constituting a converted Gc member with a different vertex in the graph, and
associating each inter-qubit operation in the converted Gc member with a different edge between a pair of vertices corresponding to that operation.

8. The method of claim 1, wherein mapping the logical qubits further comprises partitioning graph vertices into exclusive groups representing system cores such that groups number and magnitudes are constrained by a number of the system cores and a number of physical qubits within each core respectively while minimizing a total amount of resulting inter-group edges, which correspond to an amount of operations between different cores.

9. The method of claim 1, wherein the inter-operations between different cores needed to transfer qubits comprise qubit teleportation.

10. The method of claim 1, wherein determining the group of inter-operation amounts further comprises, when the Gnc member is an entire code segment, determining a corresponding group of inter-operation amounts (Gamnt) as the amount of inter-operations (Asc) associated with the Gnc member (Gse) corresponding to the entire code segment.

11. The method of claim 1, wherein determining the group of inter-operation amounts further comprises:
for any Gnc member that is not an entire code segment, determining an associated Gamnt member by summing Asc amounts associated with all the Gsc members corresponding to the any Gnc member, and
based on a determination that there are code parts outside those Gsc members, for the code parts outside those Gsc members, the determined Gamnt further includes an amount of all Cse inter-operations belonging to the code parts outside those Gsc members.

12. The method of claim 11, wherein determining the group of inter-operation amounts further comprises, for any Gnc member that is not the entire code segment, determining the associated Gamnt member by applying a penalty for code transitions between Gsc members, wherein the penalty associated with each transition is determined as the amount of inter-operations needed to transfer qubits between codes.

13. The method of claim 11, further comprising determining the optimal compiled code structure by:
selecting a Gnc member which has a minimum Gsc member;
expressing the code in physical qubit terms according to the Gsc members corresponding to the selected Gnc member and the Cse code parts outside; and
adding inter-operations for transferring qubits between cores to the code.

14. The method of claim 1, further comprising determining the amount of inter-operation amounts (Asc) is based on weighting that is associated with edges of a solver processed graphs.

15. The method of claim 14, further comprising determining the Gamnt members by using weighted sums of inter-operations comprising at least associated qubit transfer operations.

16. A non-transitory computer-readable medium storing executable instructions that, upon execution, causes a processor to map a quantum program code to a multi-core quantum computing system by performing functions comprising:
partitioning code into code segments;
identifying, from the code segments, a first group (Gc) comprising at least parts of possible contiguous sequences of the code segments;
identifying a second group (Gnc) comprising at least part of possible non-overlapping combinations of Gc members;
converting each Gc member to a corresponding graph group (Ggc);
mapping logical qubits contained in each Gc member to different physical cores;
generating a respective group of solver results (Gsc), wherein each Gsc corresponds to a respective Gc member and to its corresponding contiguous code part comprising physical qubits;
determining an amount of inter-operations (Asc) related to the contiguous code part corresponding to a respective Gsc;
determining a group of inter-operation amounts (Gamnt) based on the Asc; and
determining an optimal compiled code structure having a smallest amount of Gamnt members.

17. The non-transitory computer-readable medium of claim 16, wherein the code is segmented to two or more segments based on identifying code characteristics between adjacent segments.

18. The non-transitory computer-readable medium of claim 16, wherein each identified group may have a minimum length difference in regards to inter-qubit logical operations.

19. The non-transitory computer-readable medium of claim 16, wherein at least part of the code segments are predetermined according to limiting qubit distribution in a segment by a ratio between a number of different qubits in a segment to a total number of inter-qubit operations not being greater than a predetermined threshold.

20. The non-transitory computer-readable medium of claim 16, wherein the inter-operations between different cores needed to transfer qubits comprise qubit teleportation.
